(19) United States
(12) Patent Application Publication
(10) Pub. No.: US 2021/0289691 A1
(43) Pub. Date: Sep. 23, 2021

(54) METHOD FOR FERTILIZING CORN IN SEMI-HUMID REGION FOR ONE TIME

(71) Applicant: Institute of Agricultural Resources and Environment, Shandong Academy of Agricultural Sciences, Licheng District (CN)

(72) Inventors: Deshui Tan, Licheng District (CN); Zhaohui Liu, Licheng District (CN); Lihua Jiang, Licheng District (CN); Yan Li, Licheng District (CN); Haitao Lin, Licheng District (CN); Xiaobin Wu, Licheng District (CN); Jianlin Wei, Licheng District (CN); Yan Li, Licheng District (CN); Fuli Zheng, Licheng District (CN); Guoliang Zhu, Licheng District (CN); Zishuang Li, Licheng District (CN)

(21) Appl. No.: 16/826,753

(22) Filed: Mar. 23, 2020

(51) Int. Cl. A01C 21/00; C05G 3/40; C05B 1/02; C05B 1/04; C05B 9/00; C05D 1/02; C05G 5/30; C05B 7/00; C05C 9/00

(52) U.S. Cl. CPC A01C 21/005; C05G 3/40; C05B 1/02; C05B 1/04; C05B 9/00; C05G 5/36; C05G 5/37; C05G 5/38; C05B 7/00; C05C 9/00; C05D 1/02

(57) ABSTRACT

The present invention relates to a method for fertilizing corn in a semi-humid region for one time, and belongs to the field of agricultural fertilization. The method adopts a corn seeding and fertilizing combined machine to sow and fertilize for one time in a semi-humid region. The method realizes nutrient supply throughout the growth of corn without performing top dressing in a later stage. The method improves fertilizer utilization, saves labor cost and improves production and income. The present invention effectively improves ventilation and light transmission conditions in the corn field, eliminates the effect of a stubble of a preceding crop on the emergence of corn, improves uniformity, and reduces nutrient loss.

### TECHNICAL FIELD

The present invention belongs to the technical field of agricultural fertilization, and particularly relates to a method for fertilizing corn in a semi-humid region for one time.

### BACKGROUND

Corn is one of the most widely planted crops in the world, with its cultivated area and total output ranking the third only after rice and wheat. Corn is grown from 58° north (Canada and Russia) to 40° south (South America, Africa), and there is corn maturing every month in the world. The cultivated area and output of corn plays an important role in ensuring the food security of a country and the world. As a heat-lover, corn adapts to most environments in the world, and their growing zones are mainly distributed in semi-humid regions. In recent years, with the decline in the economic benefits of crop planting, the cultivation and management of crops has been paid less and less attention by farmers, and harvest has not been as concerned as at the end of the last century. Taking Shandong province of China as an example, the cultivated area of corn has declined for the second consecutive year. Although the declined area is not large, it also passes a negative signal, which obviously does not conform to China's food development strategy. The phenomenon does not occur by accident, but mainly due to the following reasons. First, the price of agricultural products fluctuates largely between years, and the price of agricultural inputs rises faster than grain price, so that the cost of crop planting is high and the income of crop planting is reduced year by year. Second, traditional fertilization and cultivation methods are lagging behind. Fertilizer nutrients in agricultural production are not balanced; instead, their application is usually excessive or inadequate. The one-time excessive application of common fertilizers leads to a decline in corn yield and efficiency, and causes environmental pollution. Third, agricultural labor is short and light and simplified production equipment lacks. As more and more laborers go to cities to work, farmland management is neglected, so that poor emergence and low density are inevitable. Especially in semi-humid regions with high temperature and high humidity in summer, it is difficult for agricultural workers to work with tall and thick corn plants in the field. Further, personnel have a low technical level, which eventually results in high energy consumption, low yield and low income in corn production. With the widespread application of whole-process crop planting mechanization, more and more land is transferred to large-scale grain producers and professional cooperatives who demand high agricultural production technology. To stabilize the cultivated area of corn and increase the yield of corn, scientific researchers and agricultural extension departments should consider how to improve the benefits of crop planting under the current conditions.

Regions have taken advanced management in corn fertilization. However, at present, “basic fertilizer+top-dressing” and “one-time excessive fertilization after seedling” are usually adopted. The fertilization methods are not reasonable and are contrary to the development concept of light and simplified cultivation. Fertilizers are the need to develop modern grain production and the basic guarantee for increasing grain production. Commonly available fast-acting fertilizers have a short period of validity. Therefore, corn must be fertilized in several stages (some farmers sow and fertilize for the first time separately) to meet the demand of corn for nutrients throughout the stage of growth. The nutrients are mainly nitrogen which is easily lost in gaseous and aqueous forms. Phosphorus and potassium nutrients are easily absorbed when applied to the soil. This increases the production steps and is laborious. In addition, corn plants are easy to damage by human, livestock and machinery during second fertilization. Some farmers omit second fertilization due to the limit of labor, materials and weather (especially in high-temperature high-humidity semi-humid regions) etc. As a result, the yield and income of corn are inevitably affected. Therefore, a simplified fertilization method is urgently needed to promote corn production in semi-humid regions in all aspects from saving labor costs, saving energy, reducing fertilizer application, increasing fertilizer efficiency, stabilizing and increasing the yield and reducing environmental pollution, etc.

The key to solving the problem is to break through the traditional fertilization habit and innovate the fertilization technology. In order to improve fertilizer utilization, reduce production cost, simplify the production and increase the yield and income of corn, the present invention provides a one-time corn fertilization method for a semi-humid region. Existing related patented methods are mainly production methods and techniques of slow/controlled-release fertilizers for corn. For example, a Chinese patent document (application number 200410088480.8) discloses a production process of slowly/controlled releasing fertilizer for summer corn. This production process prepares cemented and coated cemented slow-release fertilizers that are released in different periods. The nutrient release periods of the slow-release fertilizers are basically consistent with the nutrient requirements of corn in different growth stages by making different granules releasing with different speeds. In this way, the one-time fertilization meets the nutrient requirements of corn throughout the growth. However, this patented technology does not define the method of fertilization, and the fertilizer products are not abundant. A Chinese patent document (application number 201410816247.0) discloses a special slow controlled release fertilizer composition for summer maize as well as preparation method and application of composition. The patent defines raw materials of the slow controlled release fertilizer composition and sowing and fertilization methods including a horizontal spacing from a seed and fertilizer application rate. However, it does not provide a specific operation method or mention a depth of a fertilizer or a specific field cultivation technique. A Chinese patent document (application number 201310026080.3) discloses a method for sowing and fertilizing wheat and corn in minimum and no-till soil under complete straw incorporation. However, this method does not define a type of a slow/controlled-release fertilizer for corn, or a specific fertilizer nutrient input according to corn yield and soil fertility.

### SUMMARY

In view of this, an objective of the present invention is to provide a method for fertilizing corn in a semi-humid region for one time. The method provided by the present invention ensures no shortage of fertilizer in earlier and later growth stages of corn.

To achieve the above purpose, the preset invention provides the following technical solution: The present invention provides a method for fertilizing corn in a semi-humid region for one time, including the following steps:

sowing a corn seed in wide and narrow rows, a narrow row having a width of 20-30 cm and a wide row having a width of 80-90 cm; and opening a fertilization furrow between every two narrow rows, where the fertilization furrow has a depth of 10-15 cm; a sowing depth is 3-5 cm; the corn seed is sown together with application of a fertilizer;

the fertilizer includes a nitrogen fertilizer, a phosphorus fertilizer and a potassium fertilizer; when a plow layer has a thickness>20 cm, and a 0-20 cm soil layer has a soil organic matter>2.0%, a total nitrogen>0.125%, an alkali-hydrolyzable nitrogen>120 mg/kg, a rapidly available phosphorus>30 mg/kg, a rapidly available potassium>150 mg/kg and a pH of 6.0-8.0, the nitrogen fertilizer (pure N) has an application rate of 225-285 kg/hm², the phosphorus fertilizer (P₂O₅) has an application rate of 105-165 kg/hm², and the potassium fertilizer (K₂O) has an application rate of 120-180 kg/hm²;

when a plow layer has a thickness of 15-20 cm, and a 0-20 cm soil layer has a soil organic matter of 1.5-2.0%, a total nitrogen of 0.10-0.125%, an alkali-hydrolyzable nitrogen of 90-120 mg/kg, a rapidly available phosphorus of 20-30 mg/kg, a rapidly available potassium of 100-150 mg/kg and 8.0<pH≤8.5 or 5.5≤pH≤6.0, the nitrogen fertilizer (pure N) has an application rate of [165,225) kg/hm², the phosphorus fertilizer (P₂O₅) has an application rate of [75,105) kg/hm², and the potassium fertilizer (K₂O) has an application rate of [90,120) kg/hm²;

when a plow layer has a thickness<15 cm, and a 0-20 cm soil layer has a soil organic matter<1.5%, a total nitrogen<0.10%, an alkali-hydrolyzable nitrogen<90 mg/kg, a rapidly available phosphorus<20 mg/kg, a rapidly available potassium<100 mg/kg and 8.5<pH 8.5 or 5.0≤pH<5.5, the nitrogen fertilizer (pure N) has an application rate of [120,165) kg/hm², the phosphorus fertilizer (P₂O₅) has an application rate of [45,75) kg/hm², and the potassium fertilizer (K₂O) has an application rate of [60,90) kg/hm²;

Preferably, when the nitrogen fertilizer includes a water-based resin-coated controlled-release nitrogen fertilizer for corn and a fast-acting nitrogen fertilizer, the water-based resin-coated controlled-release nitrogen fertilizer for corn accounts for 80% to 90% by mass of total pure nitrogen input and the fast-acting nitrogen fertilizer accounts for 10% to 20% by mass of total pure nitrogen input.

Preferably, when the nitrogen fertilizer includes a polyurethane-coated controlled-release nitrogen fertilizer for corn and a fast-acting nitrogen fertilizer, the polyurethane-coated controlled-release nitrogen fertilizer for corn accounts for 80% to 90% by mass of total pure nitrogen input and the fast-acting nitrogen fertilizer accounts for 10% to 20% by mass of total pure nitrogen input.

Preferably, when the nitrogen fertilizer includes a stable slow-release fertilizer for corn and a fast-acting nitrogen fertilizer, the stable slow-release fertilizer for corn accounts for 80% to 90% by mass of total pure nitrogen input and the fast-acting nitrogen fertilizer accounts for 10% to 20% by mass of total pure nitrogen input.

Preferably, when the nitrogen fertilizer includes an inorganic-coated controlled-release nitrogen fertilizer for corn and a fast-acting nitrogen fertilizer, the inorganic-coated controlled-release nitrogen fertilizer for corn accounts for 80% to 90% by mass of total pure nitrogen input and the fast-acting nitrogen fertilizer accounts for 10% to 20% by mass of total pure nitrogen input.

Preferably, when the nitrogen includes humic acid urea for corn, the humic acid urea for corn has a nitrogen content≥28%.

Preferably, when the nitrogen fertilizer includes an organic polymer-coated controlled-release nitrogen fertilizer for corn and a fast-acting nitrogen fertilizer, the thermosetting/thermoplastic organic polymer-coated controlled-release nitrogen fertilizer for corn accounts for 60% to 90% by mass of total pure nitrogen input and the fast-acting nitrogen fertilizer accounts for 10% to 40% by mass of total pure nitrogen input;

the organic polymer-coated controlled-release nitrogen fertilizer for corn includes a thermosetting organic polymer-coated controlled-release nitrogen fertilizer for corn and/or a thermoplastic organic polymer-coated controlled-release nitrogen fertilizer for corn.

Preferably, the fertilizer has a diameter of 2-4 mm and a particle hardness greater than 30 N. Preferably, the phosphorus fertilizer includes one or more of monoammonium phosphate, diammonium phosphate, calcium superphosphate and double superphosphate.

Preferably, the potassium fertilizer includes one or more of potassium chloride, potassium sulfate and phosphorus-potassium compound fertilizer.

The present invention has the following beneficial effects:

1. The present invention avoids seedling injury caused by the one-time excessive application of an ordinary high-nitrogen compound fertilizer in traditional corn production and saves the labor of top-dressing in a later stage in some areas. In consideration of a climatic characteristic of a semi-humid region and the nitrogen supply of the entire growth stage of corn, the present invention combines a suitable slow/controlled-release nitrogen fertilizer with common urea for one-time application. This ensures no shortage of fertilizer in earlier and later stages of growth.

2. The present invention designs wide and narrow rows, which make full use of environmental factors such as light, temperature and air, improve ventilation and light transmission conditions, and increase the planting density.

3. The present invention provides a fertilizer furrow between two narrow rows of corn for nutrient supply. The method improves fertilizer nutrient utilization compared to a traditional fertilization method. Meanwhile, compared to a traditional method applying a furrow of fertilizer to a row of corn, the method reduces a number of furrows by 50%, reduces the workload of mechanical furrowing, and improves the efficiency of mechanical work.

4. The present invention rationally inputs nitrogen, phosphorus and potassium nutrients according to the soil fertility, which reduces the nitrogen fertilizer input (especially the nitrogen input) by 15% to 20% compared with a traditional method. The present invention sows and fertilizes at the same time to eliminate production steps including top-dressing in a later stage and reduce labor input. The present invention ensures stable and higher corn production, and increases a net income by 1800-2400 yuan/hm².

5. The present invention effectively reduces nutrient loss via a surface runoff generated by irrigation or rainwater. Meanwhile, the present invention reduces ammonia volatilization by more than 20%, increases nitrogen fertilizer utilization by 5% to 8%, and effectively improves the ecological environment.

### DETAILED DESCRIPTION

The present invention provides a method for fertilizing corn in a semi-humid region for one time, including the following steps:

sowing a corn seed in wide and narrow rows, a narrow row having a width of 20-30 cm and a wide row having a width of 80-90 cm; and opening a fertilization furrow between every two narrow rows, where the fertilization furrow has a depth of 10-15 cm; a sowing depth is 3-5 cm; the corn seed is sown together with application of a fertilizer.

The fertilizer includes a nitrogen fertilizer, a phosphorus fertilizer and a potassium fertilizer. When a plow layer has a thickness >20 cm, and a 0-20 cm soil layer has a soil organic matter >2.0%, a total nitrogen >0.125%, an alkali-hydrolyzable nitrogen >120 mg/kg, a rapidly available phosphorus >30 mg/kg, a rapidly available potassium >150 mg/kg and a pH of 6.0-8.0, the nitrogen fertilizer (pure N) has an application rate of 225-285 kg/hm², the phosphorus fertilizer (P₂O₅) has an application rate of 105-165 kg/hm², and the potassium fertilizer (K₂O) has an application rate of 120-180 kg/hm².

When a plow layer has a thickness of 15-20 cm, and a 0-20 cm soil layer has a soil organic matter of 1.5-2.0%, a total nitrogen of 0.10-0.125%, an alkali-hydrolyzable nitrogen of 90-120 mg/kg, a rapidly available phosphorus of 20-30 mg/kg, a rapidly available potassium of 100-150 mg/kg and 8.0<pH <8.5 or 5.5<pH <6.0, the nitrogen fertilizer (pure N) has an application rate of [165,225) kg/hm², the phosphorus fertilizer (P₂O₅) has an application rate of [75,105) kg/hm², and the potassium fertilizer (K₂O) has an application rate of [90,120) kg/hm².

When a plow layer has a thickness <15 cm, and a 0-20 cm soil layer has a soil organic matter <1.5%, a total nitrogen <0.10%, an alkali-hydrolyzable nitrogen <90 mg/kg, a rapidly available phosphorus <20 mg/kg, a rapidly available potassium <100 mg/kg and 8.5 <pH 8.5 or 5.0 <pH <5.5, the nitrogen fertilizer (pure N) has an application rate of [120,165) kg/hm², the phosphorus fertilizer (P₂O₅) has an application rate of [45,75) kg/hm², and the potassium fertilizer (K₂O) has an application rate of [60,90) kg/hm².

In the present invention, a planting zone of the corn is preferably in a semi-humid region. In the present invention, a sowing density of the corn seed is preferably 67,500-75,000 seeds/hm².

In the present invention, a corn sowing and fertilizing combined machine with a rotary strip cultivator is preferably used for operation; a strip preferably has a width of 8-12 cm, and a rotary cultivation depth of soil is preferably 6-10 cm. In the present invention, the corn sowing and fertilizing combined machine is designed with a rotary blade, a furrow opener, a roller, a gear, a chain and a knob, etc.; the rotary blade is at a front end of the furrow opener; seed, fertilizer and transmission devices of the combined machine are separated. During operation, a sower advances, the rotary blade performs rotary cultivation at a front end to form a cultivated strip, and the gear and the chain drive a seeder and a fertilizer distributor to rotate, so that the seed and the fertilizer drop correspondingly. After sowing and fertilizing, the seed and the fertilizer are covered with the soil, and the soil is rolled by the roller. The furrow seeder has a furrowing position within a range of the cultivated strip. The present invention has no special limit on a source of the corn sowing and fertilizing combined machine, but a product of Shandong Qufu Forestry Machinery Co., Ltd is preferred. In the present invention, the rotary cultivation loosens local soil to eliminate the effect of a stubble of a preceding crop on the emergence of the corn. This improves the cords emergence rate and uniformity, promotes the deep growth of a root, and facilitates rainwater accumulation and infiltration to improve water use efficiency.

In the present invention, when the nitrogen fertilizer preferably includes a water-based resin-coated controlled-release nitrogen fertilizer for corn and a fast-acting nitrogen fertilizer, the water-based resin-coated controlled-release nitrogen fertilizer for corn accounts for 80% to 90% by mass of total pure nitrogen input and the fast-acting nitrogen fertilizer accounts for 10% to 20% by mass of total pure nitrogen input. In the present invention, the water-based resin-coated controlled-release nitrogen fertilizer for corn preferably has an initial nitrogen release rate ≤12%, a 28-day cumulative nutrient release rate ≤75%, and a cumulative nutrient release rate ≥80% in a nitrogen nutrient release period ≥60 days. In the present invention, the fast-acting nitrogen fertilizer preferably includes urea, monoammonium phosphate or diammonium phosphate; the urea preferably has a nitrogen content of 46% or more, the monoammonium phosphate preferably has a nitrogen content of 12% or more, and the diammonium phosphate preferably has a nitrogen content of 18% or more. The present invention has no special limit on a source of the fertilizer, and a conventional commercial product may be used.

In the present invention, when the nitrogen fertilizer preferably includes a polyurethane-coated controlled-release nitrogen fertilizer for corn and a fast-acting nitrogen fertilizer, the polyurethane-coated controlled-release nitrogen fertilizer for corn accounts for 80% to 90% by mass of total pure nitrogen input and the fast-acting nitrogen fertilizer accounts for 10% to 20% by mass of total pure nitrogen input. In the present invention, the polyurethane-coated controlled-release nitrogen fertilizer for corn preferably has an initial nitrogen release rate ≤12%, a 28-day cumulative nutrient release rate ≤75%, and a cumulative nutrient release rate ≥80% in a nitrogen nutrient release period ≥60 days. In the present invention, the fast-acting nitrogen fertilizer preferably includes urea, monoammonium phosphate or diammonium phosphate; the urea preferably has a nitrogen content of 46% or more, the monoammonium phosphate preferably has a nitrogen content of 12% or more, and the diammonium phosphate preferably has a nitrogen content of 18% or more. The present invention has no special limit on a source of the fertilizer, and a conventional commercial product may be used.

In the present invention, when the nitrogen fertilizer preferably includes a stable slow-release fertilizer for corn and a fast-acting nitrogen fertilizer, the stable slow-release fertilizer for corn accounts for 80% to 90% by mass of total pure nitrogen input and the fast-acting nitrogen fertilizer accounts for 10% to 20% by mass of total pure nitrogen input. In the present invention, the stable slow-release fertilizer for corn is preferably a slow-release fertilizer to which a urease inhibitor and a nitrification inhibitor are added at a ratio of 1.5% to 3% by mass based on a total pure nitrogen nutrient; the urease inhibitor and the nitrification inhibitor preferably have a mass ratio of 1:1; the nitrogen fertilizer has a period of validity stable at 60-75 days. The present invention has no special limit on a type and a source of the urease inhibitor and the nitrification inhibitor, and a conventional commercial product may be used. In the present invention, the fast-acting nitrogen fertilizer preferably includes urea, monoammonium phosphate or diammonium phosphate; the urea preferably has a nitrogen content of 46% or more, the monoammonium phosphate preferably has a nitrogen content of 12% or more, and the diammonium phosphate preferably has a nitrogen content of 18% or more. The present invention has no special limit on a source of the fertilizer, and a conventional commercial product may be used.

In the present invention, when the nitrogen fertilizer preferably includes an inorganic-coated controlled-release nitrogen fertilizer for corn and a fast-acting nitrogen fertilizer, the inorganic-coated controlled-release nitrogen fertilizer for corn accounts for 80% to 90% by mass of total pure nitrogen input and the fast-acting nitrogen fertilizer accounts for 10% to 20% by mass of total pure nitrogen input. In the present invention, the inorganic-coated controlled-release nitrogen fertilizer for corn preferably has a nitrogen release period ≥60 days. In the present invention, the fast-acting nitrogen fertilizer preferably includes urea, monoammonium phosphate or diammonium phosphate; the urea preferably has a nitrogen content of 46% or more, the monoammonium phosphate preferably has a nitrogen content of 12% or more, and the diammonium phosphate preferably has a nitrogen content of 18% or more. The present invention has no special limit on a source of the fertilizer, and a conventional commercial product may be used.

In the present invention, when the nitrogen fertilizer preferably includes humic acid urea for corn, the humic acid urea for corn preferably has a nitrogen content ≥28%. The present invention has no special limit on a source of the fertilizer, and a conventional commercial product may be used.

In the present invention, when the nitrogen fertilizer preferably includes a thermosetting/thermoplastic organic polymer-coated controlled-release nitrogen fertilizer for corn and a fast-acting nitrogen fertilizer, the thermosetting/thermoplastic organic polymer-coated controlled-release nitrogen fertilizer for corn accounts for 60% to 90% by mass of total pure nitrogen input and the fast-acting nitrogen fertilizer accounts for 10% to 40% by mass of total pure nitrogen input. In the present invention, the organic polymer-coated controlled-release nitrogen fertilizer for corn preferably includes a thermosetting organic polymer-coated controlled-release nitrogen fertilizer for corn and/or a thermoplastic organic polymer-coated controlled-release nitrogen fertilizer for corn. In the present invention, the thermosetting/thermoplastic organic polymer-coated controlled-release nitrogen fertilizer for corn preferably has an initial nitrogen release rate ≤12%, a 28-day cumulative nutrient release rate ≤75%, and a cumulative nutrient release rate ≥80% in a nitrogen release period; if the product has a nitrogen nutrient release period ≥60 days and <75 days, the product is used in combination with 10% to 20% of fast-acting nitrogen fertilizer; if the product has a nitrogen nutrient release period ≥75 days, the product is used in combination with 20% to 40% of fast-acting nitrogen fertilizer. In the present invention, the fast-acting nitrogen fertilizer preferably includes urea, monoammonium phosphate or diammonium phosphate; the urea preferably has a nitrogen content of 46% or more, the monoammonium phosphate preferably has a nitrogen content of 12% or more, and the diammonium phosphate preferably has a nitrogen content of 18% or more. The present invention has no special limit on a source of the fertilizer, and a conventional commercial product may be used.

In the present invention, the fertilizer preferably has a diameter of 2-4 mm, and a particle hardness greater than 30 N.

In the present invention, the phosphorus fertilizer preferably includes one or more of monoammonium phosphate, diammonium phosphate, calcium superphosphate and double superphosphate, and the potassium fertilizer preferably includes one or more of potassium chloride, potassium sulfate and phosphorus-potassium compound fertilizer. The present invention has no special limit on a source of the fertilizer, and a conventional commercial product may be used.

The technical solutions provided by the present invention are described in detail below with reference to the embodiments, but the protection scope of the present invention is not limited thereto.

“%” in the embodiments refers to a mass percentage.

### Embodiment 1

A method for fertilizing corn in a semi-humid region for one time, including the following steps:

(1) In a plot under a wheat-corn rotation system in a semi-humid region, after wheat is harvested, a corn seeding and fertilizing combined machine with a rotary strip blade enters the plot to sow corn and fertilize for one time.

(2) During operation, a sower advances, and the rotary blade performs rotary cultivation at a front end to form a 12 cm wide strip. Soil is loosened to a depth of 10 cm. A gear and a chain drive a seeder and a fertilizer distributor to rotate, so that a seed and a fertilizer drop correspondingly. A seed furrow opener opens a 4 cm deep furrow, and a fertilizer furrow opener opens a 15 cm deep furrow. After sowing and fertilizing, the seed and the fertilizer are covered with the soil, and the soil is rolled by a roller. The seed furrow opener has a furrowing position within a width range of the cultivated strip.

Wide and narrow rows are opened for sowing, with a narrow row spacing of 20 cm and a wide row spacing of 90 cm. The corn is sown at a depth of 4 cm. All fertilizers with a suitable and uniform ratio are applied to a fertilizer furrow. The fertilizer furrow is between two narrow seed rows (furrows). The fertilizer furrow has a lateral distance of 10 cm away from each of the two narrow rows of corn seed and a vertical distance of 11 cm away from the seed. The sowing and fertilizing machine performs single-seed sowing. A knob is used to adjust a plant spacing and control a sowing density to 75,000 plants/hm² Thinning and final singling are not needed after emergence, and no top dressing is performed in a later stage of growth.

A. Type of Fertilizer

A water-based resin-coated controlled-release nitrogen fertilizer is used in combination with 10% of fast-acting nitrogen fertilizer. The controlled-release nitrogen fertilizer has an initial nitrogen release rate ≤12%, a nitrogen release period ≥60 days, and a cumulative nutrient release rate ≥80% in the nitrogen release period. The fast-acting nitrogen fertilizer is common urea with a nitrogen content N≥46%. A phosphorus fertilizer uses double superphosphate. A potassium fertilizer uses granular potassium chloride. The fertilizer has a regular granular shape with a diameter of 2 mm and a particle hardness of 30 N.

B. Fertilizer Application Rate

The controlled-release nitrogen fertilizer (N) has an application rate of 270 kg/hm², the phosphorus fertilizer (P₂O₅) has an application rate of 135 kg/hm², and the potassium fertilizer (K₂O) has an application rate of 165 kg/hm² in case of high-fertility soil, that is, when a plow layer has a thickness >20 cm, and a 0-20 cm soil layer has a soil organic matter >2.0%, a total nitrogen >0.125%, an alkali-hydrolyzable nitrogen >120 mg/kg, a rapidly available phosphorus >30 mg/kg, a rapidly available potassium >150 mg/kg and a pH of 6.0-8.0.

### Embodiment 2

A method for fertilizing corn in a semi-humid region for one time, including the following steps:

(1) In a plot under a wheat-corn rotation system in a semi-humid region, after wheat is harvested, a corn seeding and fertilizing combined machine with a rotary strip blade enters the plot to sow corn and fertilize for one time.

(2) During operation, a sower advances, and the rotary blade performs rotary cultivation at a front end to form a 10 cm wide strip. Soil is loosened to a depth of 8 cm. A gear and a chain drive a seeder and a fertilizer distributor to rotate, so that a seed and a fertilizer drop correspondingly. A seed furrow opener opens a 3 cm deep furrow, and a fertilizer furrow opener opens a 13 cm deep furrow. After sowing and fertilizing, the seed and the fertilizer are covered with the soil, and the soil is rolled by a roller. The seed furrow opener has a furrowing position within a width range of the cultivated strip.

Wide and narrow rows are opened for sowing, with a narrow row spacing of 26 cm and a wide row spacing of 88 cm. The corn seed is sown at a depth of 3 cm. All fertilizers with a suitable and uniform ratio are applied to a fertilizer furrow. The fertilizer furrow is between two narrow seed rows (furrows). The fertilizer furrow has a lateral distance of 13 cm away from each of the two narrow corn seed rows and a vertical distance of 10 cm away from the seed. The sowing and fertilizing machine performs single-seed sowing. A knob is used to adjust a plant spacing and control a sowing density to 72,000 plants/hm² Thinning and final singling are not needed after emergence, and no top dressing is performed in a later stage of growth.

A. Type of Fertilizer

A sulfur-coated controlled-release nitrogen fertilizer is used in combination with 20% of fast-acting nitrogen fertilizer. The controlled-release nitrogen fertilizer has a nitrogen release period ≥70 days. The fast-acting nitrogen fertilizer is common urea, with a nitrogen content N≥46%. A phosphorus fertilizer uses calcium superphosphate. A potassium fertilizer uses granular potassium sulfate. The fertilizer has a regular granular shape with a diameter of 3 mm and a particle hardness of 32 N.

B. Fertilizer Application Rate

The controlled-release nitrogen fertilizer (N) has an application rate of 225 kg/hm², the phosphorus fertilizer (P₂O₅) has an application rate of 90 kg/hm², and the potassium fertilizer (K₂O) has an application rate of 120 kg/hm² in case of intermediate-fertility soil, that is, when a plow layer has a thickness of 15-20 cm, and a 0-20 cm soil layer has a soil organic matter of 1.5-2.0%, a total nitrogen of 0.10-0.125%, an alkali-hydrolyzable nitrogen of 90-120 mg/kg, a rapidly available phosphorus of 20-30 mg/kg, a rapidly available potassium of 100-150 mg/kg and 8.0<pH≤8.5 or 5.5 ≤pH≤6.0.

### Embodiment 3

A method for fertilizing corn in a semi-humid region for one time, including the following steps:

(1) In a plot under a wheat-corn rotation system in a semi-humid region, after wheat is harvested, a corn seeding and fertilizing combined machine with a rotary strip blade enters the plot to sow corn and fertilize for one time.

(2) During operation, a sower advances, and the rotary blade performs rotary cultivation at a front end to form an 8 cm wide strip. Soil is loosened to a depth of 9 cm. A gear and a chain drive a seeder and a fertilizer distributor to rotate, so that a seed and a fertilizer drop correspondingly. A seed furrow opener opens a 3.5 cm deep furrow, and a fertilizer furrow opener opens a 12 cm deep furrow. After sowing and fertilizing, the seed and the fertilizer are covered with the soil, and the soil is rolled by a roller. The seed furrow opener has a furrowing position within a width range of the cultivated strip.

Wide and narrow rows are opened for sowing, with a narrow row spacing of 30 cm and a wide row spacing of 80 cm. The corn seed is sown at a depth of 3.5 cm. All fertilizers with a suitable and uniform ratio are applied to a fertilizer furrow. The fertilizer furrow is between two narrow seed rows (furrows). The fertilizer furrow has a lateral distance of 15 cm away from each of the two narrow corn seed rows and a vertical distance of 8.5 cm away from the seed. The sowing and fertilizing machine performs single-seed sowing. A knob is used to adjust a plant spacing and control a sowing density to 69,000 plants/hm² Thinning and final singling are not needed after emergence, and no top dressing is performed in a later stage of growth.

A. Type of Fertilizer

A thermosetting organic polymer-coated controlled-release nitrogen fertilizer is used in combination with 30% of fast-acting nitrogen fertilizer. The controlled-release nitrogen fertilizer has an initial nitrogen release rate ≤12%, a nitrogen release period ≥75 days, and a cumulative nutrient release rate ≥80% in the nitrogen release period. The fast-acting nitrogen fertilizer is common urea with a nitrogen content N ≥46%. A phosphorus fertilizer uses double superphosphate. A potassium fertilizer uses granular potassium chloride. The fertilizer has a regular granular shape with a diameter of 4 mm and a particle hardness of 30 N.

B. Fertilizer Application Rate

The controlled-release nitrogen fertilizer (N) has an application rate of 165 kg/hm², the phosphorus fertilizer (P₂O₅) has an application rate of 60 kg/hm², and the potassium fertilizer (K₂O) has an application rate of 75 kg/hm² in a low-fertility soil, that is, when a plow layer has a thickness<15 cm, and a 0-20 cm soil layer has a soil organic matter <1.5%, a total nitrogen <0.10%, an alkali-hydrolyzable nitrogen <90 mg/kg, a rapidly available phosphorus <20 mg/kg, a rapidly available potassium<100 mg/kg and 8.5<pH 8.5 or 5.0≤pH<5.5.

The beneficial effects of the present invention are verified by the following experimental examples.

### EXPERIMENTAL EXAMPLE 1

A method for fertilizing corn in a semi-humid region for one time in Embodiment 1 was compared with a local traditional sowing and fertilization method of equal nutrient input. The traditional fertilization method includes: perform sowing and fertilization separately, that is, sow with an equal row spacing of 60, and perform first fertilization by in-furrow application after emergence; and top-dress (second fertilization) by spreading between corn rows in a middle stage of corn growth. The experiment was conducted in 2016 in a semi-humid region in Zhaoyuan, Laizhou and Muping in the eastern Huang-Huai-Hai Plain. The nutrients input by the traditional sowing and fertilization method were the same as those in Embodiment 1. Nitrogen, phosphorus and potassium were derived from a nitrogen, phosphorus and potassium compound fertilizer and urea. An ordinary corn sower was used to perform traditional stubble-covered no-till direct sowing, with a sowing depth of 4 cm. Final singling and first fertilization were performed in a 3-leaf stage after emergence. A 15 cm deep furrow was opened, with a lateral distance of 10 cm away from a seedling, to apply the compound fertilizer. Second fertilization was performed in a big-bell stage, that is, the urea was spread between rows. The two applications of the nitrogen fertilizer had a ratio of 1:2; the input of other medium trace elements was the same as that in Embodiment 1. Except that the traditional method added final singling to guarantee a uniform plant density in the field, other field management operations were the same as the one-time fertilization method of the present invention. Table 1 provides a comparison analysis of two experimental sites in terms of output, cost and income, etc.

TABLE 1
Comparison of one-time corn fertilization method with traditional fertilization

| | Emergence | Labor Input | Grain Yield | Net Income | Farmer |
|---|---|---|---|---|---|
| | Rate (%) | (labor/hm²) | (kg/hm²) | (yuan/hm²) | Acceptance (%) |
| Traditional | 93.6 | 60 | 10800 | 5490 | 5.7 |
| sowing and | | | | | |
| fertilization | | | | | |
| method | | | | | |
| One-time | 97.4 | 30 | 11340 | 7840 | 94.3 |
| fertilization | | | | | |
| method | | | | | |

As can be seen from Table 1 that the emergence rate of the one-time corn fertilization method was 3.8% higher than the traditional sowing and fertilization method. This is because the present invention adopted rotary strip cultivation, which eliminated the effect of a wheat stubble on the emergence of corn. This emergence rate reduced the amount of corn seeds used, ensured a higher density and decreased the cost of final singling. Compared with the traditional method performing the fertilization and sowing separately and performing top-dressing in a later stage, the present invention adopted one-time sowing and fertilization, which could save 30 labors per hm² and free up the manpower for other tasks. Although the present invention omitted the later top-dressing with nitrogen, the average grain yield in three sites was 540 kg/hm², 5% higher than the traditional method. After deducting the costs of labor and fertilizers, the net income of the present invention was increased by 2,350 yuan/hm², indicating an obvious benefit. A survey of acceptance of the two methods was carried out among farmers randomly selected from where the experiment was conducted. The results show that the acceptance was dominated by the one-time fertilization method of the present invention, which accounted for 94.3%.

### EXPERIMENTAL EXAMPLE 2

A method for fertilizing corn in a semi-humid region for one time in Embodiment 2 was compared with a local traditional fertilization method. The experiment was conducted in 2017 in a semi-humid region in 8 typical counties and cities of Hebei, Henan and Shandong provinces. The nutrients input by the traditional fertilization method were the same as those in Embodiment 2. Nitrogen, phosphorus and potassium were derived from a nitrogen, phosphorus and potassium compound fertilizer and urea. An ordinary corn sowing and fertilizing machine was used to perform no-till sowing and fertilization at an equal row spacing of 62 cm and a sowing depth of 3 cm. Sowing and fertilizing were simultaneous. The nitrogen, phosphorus and potassium compound fertilizer was used as a base fertilizer. The fertilizer was applied with a lateral distance of 13 cm and a vertical distance of 10 cm away from a seed. Urea was spread in a small-bell stage. The base fertilizer and the top-dressing had a ratio of 3:7. The input of other medium trace elements was the same as that in Embodiment 2. Except that the traditional method added thinning and final singling in a 3-leaf stage, other field management operations were the same as the one-time fertilization method of the present invention. Table 2 provides a comparative analysis of all experimental sites in terms of average yield, cost, income, nutrient utilization and nutrient loss, etc.

TABLE 2
Comparison of one-time corn fertilization method with traditional fertilization

| | | | Partial Factor | In-season | Nitrogen |
|---|---|---|---|---|---|
| | Grain | Net | Productivity | Nitrogen | Loss via |
| | Yield | Income | of Nitrogen | Use | Surface Runoff |
| | (kg/hm²) | (yuan/hm²) | (kg/kg) | Efficiency (%) | (kg N/hm²) |
| Traditional | 8310 | 3540 | 36.9 | 29.7 | 16.5 |
| sowing and | | | | | |
| fertilization | | | | | |
| method | | | | | |
| One-time | 8760 | 5650 | 38.4 | 34.8 | 10.9 |
| fertilization | | | | | |
| method | | | | | |

The one-time corn fertilization method of the present invention was used in 8 experimental sites in the semi-humid region. As can be seen from Table 2, compared with the traditional corn sowing and fertilization method, the one-time fertilization method increased the average yield of corn by 450 kg/hm², with an increase of 5.42%. The method also increased the net income by 2,110 yuan per hm², the partial factor productivity of nitrogen by 1.5 kg/kg, and the in-season nitrogen fertilizer utilization by 5.1%. In addition, the one-time fertilization method reduced nitrogen loss while ensuring continuous fertilizer efficiency. Compared with the traditional method, the one-time fertilization method reduced the average nitrogen loss via surface runoff by 5.6 kg N/hm². Therefore, the present invention had obvious economic and ecological benefits.

### EXPERIMENTAL EXAMPLE 3

A method for fertilizing corn in a semi-humid region for one time in Embodiment 3 was compared with a traditional sowing and fertilization method with 20% higher total nutrient input. The experiment was conducted in 2017 and 2018 in low-fertility soil in a semi-humid region in Linyi, Weifang, Qingdao, Yantai and Weihai. Nitrogen, phosphorus and potassium in the traditional fertilization method were derived from a compound fertilizer and urea. An ordinary corn sowing and fertilizing machine was used to perform no-till sowing and fertilization at an equal row spacing of 67 cm and a sowing depth of 3.5 cm. Sowing and fertilizing were simultaneous. The compound fertilizer was used as a base fertilizer. The fertilizer was applied with a lateral distance of 15 cm and a vertical distance of 8.5 cm away from a seed. The urea was spread in a big-bell stage. The base fertilizer and the top-dressing had a ratio of 4:6. The input of other medium trace elements was the same as that in Embodiment 3. Except that the traditional method added thinning and final singling in a 3-leaf stage, other field management operations were the same as the one-time fertilization method of the present invention. The two methods were compared based on five experimental sites in terms of average yield, income, nutrient utilization and environmental impact, etc.

TABLE 3
Comparison of one-time corn fertilization method with traditional fertilization

| | | | | | Nitrogen |
|---|---|---|---|---|---|
| | Planting | Grain | | Nitrogen | Loss via |
| | Density | Yield | Net Income | Use | Surface Runoff |
| | (plant/hm²) | (kg/hm²) | (yuan/hm²) | Efficiency (%) | (kg N/hm²) |
| Traditional | 62670 | 6060 | 2350 | 30.4 | 10.36 |
| sowing and | | | | | |
| fertilization | | | | | |
| method | | | | | |
| One-time | 69000 | 6540 | 4215 | 36.1 | 7.28 |
| fertilization | | | | | |
| method | | | | | |

As can be seen from Table 3, compared with the traditional corn sowing and fertilization method, the one-time corn fertilization method had a higher planting density, which was due to the use of wide and narrow row sowing. In the traditional method, the planting density was smaller, and the type and application rate of the nitrogen fertilizer were improper, which caused the injury of some seedlings. Although the traditional sowing and fertilization method input 20% higher nutrients, the average grain yield of the five experimental plots using the one-time fertilization method was increased by 480 kg/hm², with an increase of 7.92%. In addition, the average income was increased by 1,865 yuan/hm²; the nitrogen fertilizer utilization was increased by 5.7%; and the nitrogen loss via surface runoff was reduced by 3.08 kg N/hm². Therefore, the fertilizer application of the present invention had a less potential threat of environmental pollution and had a better technical effect.

The above described are merely preferred implementations of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A method for fertilizing corn in a semi-humid region for one time, comprising the following steps:
sowing a corn seed in wide and narrow rows, a narrow row having a width of 20-30 cm and a wide row having a width of 80-90 cm; and opening a fertilization furrow between every two narrow rows, wherein the fertilization furrow has a depth of 10-15 cm; a sowing depth is 3-5 cm; the corn seed is sown together with application of a fertilizer;
the fertilizer comprises a nitrogen fertilizer, a phosphorus fertilizer and a potassium fertilizer;
when a plow layer has a thickness >20 cm, and a 0-20 cm soil layer has a soil organic matter >2.0%, a total nitrogen >0.125%, an alkali-hydrolyzable nitrogen >120 mg/kg, a rapidly available phosphorus >30 mg/kg, a rapidly available potassium >150 mg/kg and a pH of 6.0-8.0, the nitrogen fertilizer (pure N) has an application rate of 225-285 kg/hm², the phosphorus fertilizer (P₂O₅) has an application rate of 105-165 kg/hm², and the potassium fertilizer (K₂O) has an application rate of 120-180 kg/hm²;
when a plow layer has a thickness of 15-20 cm, and a 0-20 cm soil layer has a soil organic matter of 1.5-2.0%, a total nitrogen of 0.10-0.125%, an alkali-hydrolyzable nitrogen of 90-120 mg/kg, a rapidly available phosphorus of 20-30 mg/kg, a rapidly available potassium of 100-150 mg/kg and 8.0 <pH <8.5 or 5.5 <pH <6.0, the nitrogen fertilizer (pure N) has an application rate of [165,225) kg/hm², the phosphorus fertilizer (P2O5) has an application rate of [75,105) kg/hm², and the potassium fertilizer (K2O) has an application rate of [90,120) kg/hm²;
when a plow layer has a thickness <15 cm, and a 0-20 cm soil layer has a soil organic matter <1.5%, a total nitrogen <0.10%, an alkali-hydrolyzable nitrogen <90 mg/kg, a rapidly available phosphorus <20 mg/kg, a rapidly available potassium <100 mg/kg and 8.5 <pH 8.5 or 5.0 <pH <5.5, the nitrogen fertilizer (pure N) has an application rate of [120,165) kg/hm², the phosphorus fertilizer (P₂O₅) has an application rate of [45,75) kg/hm², and the potassium fertilizer (K₂O) has an application rate of [60,90) kg/hm²;

2. The method according to claim 1, wherein when the nitrogen fertilizer comprises a water-based resin-coated controlled-release nitrogen fertilizer for corn and a fast-acting nitrogen fertilizer, the water-based resin-coated controlled-release nitrogen fertilizer for corn accounts for 80% to 90% by mass of total pure nitrogen input and the fast-acting nitrogen fertilizer accounts for 10% to 20% by mass of total pure nitrogen input.

3. The method according to claim 1, wherein when the nitrogen fertilizer comprises a polyurethane-coated controlled-release nitrogen fertilizer for corn and a fast-acting nitrogen fertilizer, the polyurethane-coated controlled-release nitrogen fertilizer for corn accounts for 80% to 90% by mass of total pure nitrogen input and the fast-acting nitrogen fertilizer accounts for 10% to 20% by mass of total pure nitrogen input.

4. The method according to claim 1, wherein when the nitrogen fertilizer comprises a stable slow-release fertilizer for corn and a fast-acting nitrogen fertilizer, the stable slow-release fertilizer for corn accounts for 80% to 90% by mass of total pure nitrogen input and the fast-acting nitrogen fertilizer accounts for 10% to 20% by mass of total pure nitrogen input.

5. The method according to claim 1, wherein when the nitrogen fertilizer comprises an inorganic-coated controlled-release nitrogen fertilizer for corn and a fast-acting nitrogen fertilizer, the inorganic-coated controlled-release nitrogen fertilizer for corn accounts for 80% to 90% by mass of total pure nitrogen input and the fast-acting nitrogen fertilizer accounts for 10% to 20% by mass of total pure nitrogen input.

6. The method according to claim 1, wherein when the nitrogen comprises humic acid urea for corn, the humic acid urea for corn has a nitrogen content >28%.

7. The method according to claim 1, wherein when the nitrogen fertilizer comprises an organic polymer-coated controlled-release nitrogen fertilizer for corn and a fast-acting nitrogen fertilizer, the thermosetting/thermoplastic organic polymer-coated controlled-release nitrogen fertilizer for corn accounts for 60% to 90% by mass of total pure nitrogen input and the fast-acting nitrogen fertilizer accounts for 10% to 40% by mass of total pure nitrogen input;
the organic polymer-coated controlled-release nitrogen fertilizer for corn comprises a thermosetting organic polymer-coated controlled-release nitrogen fertilizer for corn and/or a thermoplastic organic polymer-coated controlled-release nitrogen fertilizer for corn.

8. The method according to claim 1, wherein the fertilizer has a diameter of 2-4 mm and a particle hardness greater than 30 N.

9. The method of claim 1, wherein the phosphorus fertilizer comprises one or more of monoammonium phosphate, diammonium phosphate, calcium superphosphate and double superphosphate.

10. The method according to claim 1, wherein the potassium fertilizer comprises one or more of potassium chloride, potassium sulfate and phosphorus-potassium compound fertilizer.
